(19) United States
(12) Patent Application Publication
(10) Pub. No.: US 2013/0242430 A1
(43) Pub. Date: Sep. 19, 2013

(54) MAGNETIC RECORDING MEDIUM, METHOD FOR MANUFACTURING MAGNETIC RECORDING MEDIUM, AND MAGNETIC RECORDING OR REPRODUCING APPARATUS

(71) Applicant: TDK CORPORATION, Tokyo (JP)

(72) Inventors: Tsutomu AOYAMA, Tokyo (JP); Yoshikazu SOENO, Tokyo (JP); Akimasa KAIZU, Tokyo (JP)

(73) Assignee: TDK CORPORATION, Tokyo (JP)

(21) Appl. No.: 13/791,306

(22) Filed: Mar. 8, 2013

(30) Foreign Application Priority Data
Mar. 16, 2012 (JP) 2012-060403

(51) Int. Cl. G11B 5/706

(52) U.S. Cl. CPC G11B 5/70621; G11B 5/70605
USPC 360/110; 428/839.6; 428/839.3; 427/595

(57) ABSTRACT

Ion irradiation is applied to the surface of a recording layer which has a granular structure containing ferromagnetic particles which are composed of an L10 ordered alloy and a non-magnetic intergranular layer, thereby the ferromagnetic particles in the side of the substrate are transformed into an L10 ordered alloy having a high magnetic anisotropy, and the ferromagnetic particles in the side of the surface of the medium are transformed into an A1 disordered alloy having a low magnetic anisotropy.

### BACKGROUND OF THE INVENTION

1. Field of the Invention

The present invention relates to a magnetic recording medium which carries out microwave magnetic recording, a method for manufacturing the magnetic recording medium, and a magnetic recording or reproducing apparatus into which the magnetic recording medium is incorporated.

2. Description of the Related Art

A high recording density is sought for a magnetic recording or reproducing apparatus such as a hard disk drive. The size of magnetic particles, which constitute a recording layer of a magnetic recording medium, needs to be lowered to achieve a high recording density, while a material having a large magnetic anisotropy energy Ku needs to be used for the magnetic recording medium in order to prevent dissipation of magnetization due to heat. However, it is difficult to achieve a head magnetic field strength necessary for recording because of a reduction in the size of a magnetic pole element of a head.

With respect to signal recording on a high Ku medium for high density recording, a microwave-assisted method has recently been gathering a lot of attention (see, for example, Japanese Unexamined Patent Application Publication No. 2009-080869).

The microwave-assisted method markedly reduces the head magnetic field necessary for signal recording (magnetization reversal of magnetic particles) and hence facilitates recording by applying, from a microwave magnetic field generating element which is placed near the recording head, a microwave magnetic field which has a frequency close to a ferromagnetic resonance frequency under the application of a head magnetic field of magnetic particles which constitute the recording layer of the magnetic recording medium, and thereby exciting precession of spins of magnetic particles.

The ferromagnetic resonance frequency of magnetic particles, Fᵣₑₛ, is represented by the following formula (1).

Fᵣₑₛ=(γ/2π) (Hk−Hₑₓₜ) (1)

Here, γ is a ferromagnetic ratio, Hk is an anisotropic magnetic field, and Hₑₓₜ is a recording magnetic field which the recording head generates. Hk is represented by the following formula (2) using the Ku and a saturation magnetization Ms.

Hk=2Ku/Ms (2)

The formula (2) shows that if a higher Ku magnetic material is used in order to achieve higher density recording, the anisotropic magnetic field Hk of the recording medium becomes larger and thereby the ferromagnetic resonance frequency Fᵣₑₛ becomes larger as indicated by formula (1). For example, a Ku of around 1×10⁷ erg/cc is necessary for attaining a recording density of 2 Tbpsi. Where Hk=25 kOe at a saturation magnetization Ms=800 emu/cc and Hk=40 kOe at a saturation magnetization Ms=500 emu/cc are reached.

In the case where the recording magnetic field is 10 kOe, Fᵣₑₛ is about 45 GHz at Hk=25 kOe and about 90 GHz at Hk=40 kOe, and since it is difficult to deal with such a high frequency, it is desired to make the frequency no higher than 20 GHz.

As a method of effectively lowering the Hk of a recording medium, for example, Japanese Unexamined Patent Application Publication No. 2007-272950 discloses a method (EGO medium) in which the recording layer of a perpendicular magnetic recording medium is divided into different Hk portions in the direction of thickness to improve recording performance. In this method, a low-Hk magnetic film (soft layer) is stacked on a high-Hk magnetic film (hard layer) and the method makes it possible to effectively lower the Hk of a recording layer.

In this method, thin films having different magnetic properties are stacked on top of one another to make a perpendicular magnetic recording medium, however, as the magnetic anisotropic energy of an ECC medium is substantially equal to the sum of the magnetic anisotropic energies of the magnetic recording layers, the magnetic anisotropic energy of a hard layer therefore needs to be larger than that of a single layer when a part of the hard layer is replaced with a soft layer. For example, the magnetic anisotropic energy of a soft layer is zero when the Hk of the soft layer is zero.

For this reason, the magnetic anisotropic energy of a hard layer needs to be doubled to replace a half of the magnetic recording layer with a soft layer, and a magnetic material having a Ku of around 2×10⁷ erg/cc needs to be used as a hard layer when the recording density is 2 Tbpsi.

An example of a magnetic material having a high magnetic anisotropic energy is an L10 ordered alloy such as an FePt alloy.

An L10 ordered alloy has a high magnetic anisotropic energy, however, a heat treatment at a temperature of around 500° C. is required after film formation in order to achieve ordering. In addition, a cluster size, which is a minimum unit of magnetization reversal, needs to be reduced to improve the recording resolution, and a granular structure in which magnetic particles are separated by a non-magnetic material is required in order to reduce the exchange interaction between magnetic particles.

In order to sufficiently use the advantageous properties of the ECC medium, a granular structure in which a stacked low anisotropic material is integrated in a high anisotropic material is preferred. However, technology for stacking a lattice-matched low anisotropic material on an L10 ordered alloy thermally treated with a high temperature has not been established yet.

Japanese Unexamined Patent Application Publication No. 2009-301685 discloses an ECC recording medium with a modified surface layer, however, no concrete modification for an L10 ordered alloy is shown there.

Japanese Unexamined Patent Application Publication No. 2005-228912 discloses that the magnetic property of a portion of an L10 ordered alloy, which is modified by a local irradiation of ions to the L10 ordered alloy, however, a method for changing the magnetic property in the direction of the thickness of an L10 ordered alloy is not disclosed.

It is necessary to lower the frequency of a microwave magnetic field to a realizable range such as 20 GHz or less using an L10 ordered alloy having a high magnetic anisotropy in the recording layer in order to realize a microwave-assisted magnetic recording medium, however, a concrete method for production of the magnetic recording medium having these properties has not been established.

### SUMMARY OF THE INVENTION

Accordingly, in view of the above described circumstances, it is an object of the present invention to provide a magnetic recording medium suitable for a microwave-assisted method using an L10 ordered alloy having a high magnetic anisotropy in the recording layer to transform the surface of the alloy into a low-anisotropic A1 disordered alloy, by which the frequency range of a microwave magnetic field is lowered to a desired range for application of the microwave-assisted method; a method for manufacturing the magnetic recording medium; and a magnetic recording or reproducing apparatus into which the magnetic recording medium is incorporated.

Above described object is achieved using following aspects.

One aspect of the present invention is a magnetic recording medium having at least a soft magnetic under laver, a non-magnetic seed layer, a magnetic recording layer, and a protection layer on a substrate, in which the magnetic recording layer has a granular structure formed of ferromagnetic crystalline particles and a non-magnetic intergranular layer, the ferromagnetic crystalline particles are composed of an ordered alloy having an L10 crystalline structure at the side, close to the substrate and a disordered alloy having an A1 crystalline structure at the side close to the surface in a direction of the thickness of the magnetic recording layer.

Another aspect of the present invention is the magnetic recording medium in which the ferromagnetic crystalline particles are composed of at least one element of Fe and Co, and at least one element of Pt and Pd as a main component.

Another aspect of the present invention is the magnetic recording medium in which the magnetic recording layer has at least one element selected from B, N, Ar, Cr, Nb, and Ga, and the concentration of the element is higher at the side close the surface and lower at the side close to the substrate.

Another aspect of the present invention is the magnetic recording medium in which the magnetic recording layers are separated by at least one non-magnetic layer.

Another aspect of the present invention is a method for manufacturing the magnetic recording medium which includes forming a disordered alloy having an Al crystalline structure by ion irradiation.

Another aspect of the present invention is the method for manufacturing the magnetic recording medium in which the ions applied by the ion irradiation are of at least one element of B, N, Ar, Cr, Nb, and Ga.

Another aspect of the Present invention is a magnetic recording or reproducing apparatus into which the magnetic recording medium is incorporated.

Another aspect of the present invention is a magnetic recording or reproducing apparatus by which a signal is recorded in the recording medium by imposing a microwave magnetic field generated from a microwave magnetic field generating element on a signal recording magnetic field generated from a recording head.

### BRIEF DESCRIPTION OF THE DRAWINGS

FIG. 1 is a schematic view of an embodiment of a magnetic recording medium according to the present invention.

FIG. 2 is a schematic view of another embodiment of a magnetic recording medium according to the present. invention.

FIG. 3 is an explanatory view illustrating an ion irradiation method according to an embodiment of the present invention.

FIG. 4 is an explanatory view illustrating an ion irradiation method according to another embodiment of the present invention.

FIG. 5 is a graph illustrating the relationship between the accelerating voltage and the depth of penetration when boron ions thereinafter referred to B ion) are applied to an FePt ordered alloy.

FIG. 6A is a graph illustrating a change in magnetic property before irradiation.

FIG. 6B is a graph illustrating a change in magnetic property after irradiation of B ions on an FePt ordered alloy.

FIG. 7 is a graph showing the relationship between the amount of irradiation and the magnetic coercive force. when B ions are applied to an FePt ordered alloy.

FIG. 8 is a graph illustrating the relationship between the amount of irradiation and the surface roughness when B ions are applied to an FePt ordered alloy.

FIG. 9 is a graph illustrating the relationship between the amount of irradiation and the crystalline structure when B ions are applied to an FePt ordered alloy.

FIG. 10 is an explanatory view illustrating a microwave assisted magnetic recording method.

FIG. 11 is a graph illustrating the influence of a microwave magnetic field on the recording and reproducing properties. The graph shows the relationship between the S/N and the microwave frequency according to an LLG simulation.

### DESCRIPTION OF THE PREFERRED EMBODIMENTS

Now, a preferred embodiment of the present invention will be described herein below with reference to the accompanying drawings.

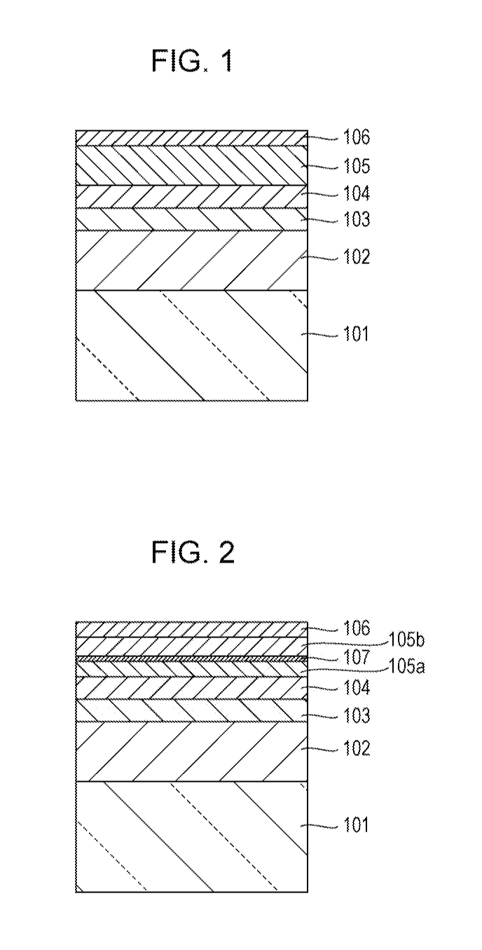

FIG. 1 is a sectional view of a magnetic recording medium according to a first embodiment of the present invention. This recording medium has a soft magnetic under layer 102, a seed layer 103, a non-magnetic seed layer 104, a magnetic recording layer 105, and a protection layer 106 all of which are stacked on a non-magnetic substrate 101.

The substrate 101 can be formed from a non-magnetic material such as glass, an Al alloy coated with NIP, ceramic, Si having an oxidized surface and the like.

The soft magnetic under layer 102 which works as a part of the magnetic head introduces a recording magnetic field from the recording head through the surface of the magnetic recording medium 100 and then inside the medium, and returns the magnetic field to the magnetic head in a horizontal direction, and therefore the role of the under layer is to apply a sharp and sufficient perpendicular magnetic field to the magnetic recording layer and improve the efficacy of recording and reproduction performances.

The soft magnetic under layer 102 can be made from an Fe alloy, a Co amorphous alloy, a ferrite or the like. The soft magnetic under layer 102 may be a multi-layer structure of a stacked soft magnetic layer and non-magnetic layer.

The seed layer 103 is provided between the soft magnetic under layer 102 and the non-magnetic seed layer 104, and the crystal size and the crystalline orientation of the magnetic recording layer 105 can be improved through the non-magnetic seed layer 104. The seed layer is not essential, however, a preferred material of the seed layer includes at least one selected from the group consisting of Cr, Mo, Pd, Pt, Ni, Ta, Ti, and their alloys. For further improvement, a mixture of any of these materials may be used, other elements may be added and these materials may be stacked.

As for the non-magnetic seed layer 104, MgO can be used.

The magnetic recording layer 105 includes an FePt alloy, a CoPt alloy, an FePd alloy, and a CoPd alloy and is formed on the non-magnetic seed layer 104 as a film with a sputtering method. The crystalline structure of these alloys after film formation is an fcc A1 disordered alloy and its magnetic: anisotropy is low. A heat treatment at a high temperature can cause a phase change of these disordered alloys to an ordered alloy having a high-magnetic anisotropic L10 crystalline structure.

FIG. 2 is a sectional view illustrating a magnetic recording medium according to a second embodiment of the present invention. This magnetic recording medium includes the soft magnetic under layer 102, the seed layer 103, the non-magnetic seed layer 104, a magnetic recording layer 105a, a non-magnetic layer 107, a magnetic recording layer 105b, and a protection layer 106 all of which are stacked on the non-magnetic substrate 101.

The non-magnetic layer 107 is a thin film which includes at least one element of Ru, Rh, Pd, Ir, and Pt.

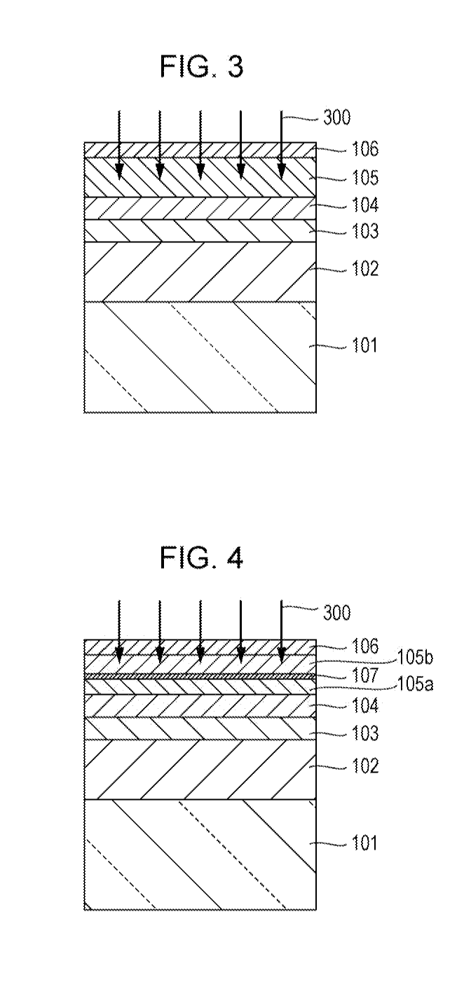

FIG. 3 illustrates a method for ion irradiation according to a first embodiment of the present invention. At least one kind of ions of B, N, Ar, Cr, Nb, and Ga are applied with an ion irradiation unit to the recording layer which has been changed to a L10 ordered alloy with a heat treatment. The energy of ion irradiation is set to a certain range in such a manner that the ions reach the surface side of the recording: layer and does not reach the opposite side of the recording layer facing the substrate, as will be illustrated below in the description of ion irradiation simulation. With this ion irradiation, the surface of the recording layer is transformed from an L10 ordered alloy to an A1 disordered alloy.

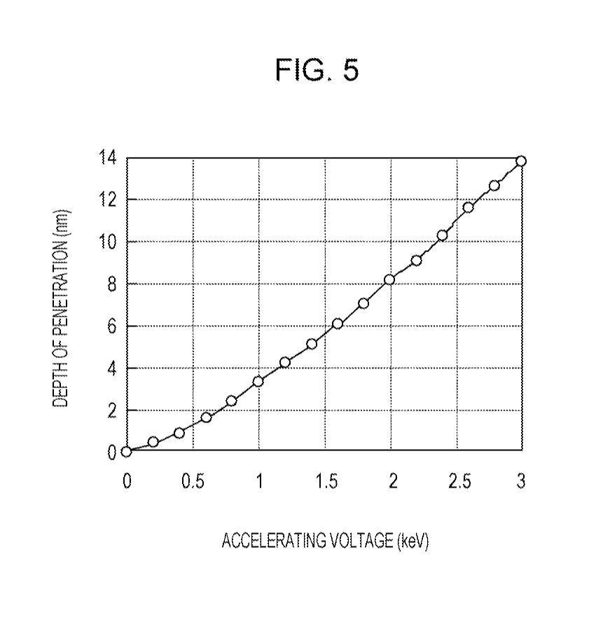

FIG. 4 illustrates an ion irradiation method according to a second embodiment of the present invention. At least one kind of ions of B, N, Ar, Cr, Nb, and Ga are applied with an ion irradiation unit to the recording layer which has been changed Lo an L10 ordered alloy with a heat treatment. The energy of ion irradiation is set to a certain range in such a manner that the ions reach the surface side of the recording layer separated by the non-magnetic layer and does not reach the surface side of the recording layer facing the substrate, as will be illustrated below in the description of ion irradiation simulation. With this ion irradiation, the surface of the recording layer separated by the non-magnetic layer is transformed from an L10 ordered alloy to an A1 disordered alloy. By adjusting the thickness of the non-magnetic layer, it is possible to change the state in which a portion, which has become a portion at low anisotropy by ion irradiation, and a high anisotropic portion are exchange coupled, and thereby the effective magnetic anisotropy Hk of the recording layer can be more precisely controlled.

FIG. 5 illustrates an example of results of a Monte Carlo simulation of ion irradiation to an L10 ordered alloy, and is a graph illustrating the relationship between the ion accelerating voltage and the depth of penetration of ions when B (boron) ions are applied to an FePt alloy. The horizontal axis represents ion accelerating voltage, and the longitudinal axis represents the depth of penetration of applied ions. The applied ions penetrate through the surface of the L10 ordered alloy repeatedly collide with atoms of the alloy until their energy are lost, and finally stop inside the alloy. The energy arising from ion collision causes interdiffusion of atoms of the ordered alloy thereby the ordered alloy is transformed into a disordered alloy. Using this simulation, the accelerating voltage necessary for a desired depth of ion penetration can be calculated.

### EXAMPLES

Herein below, the present invention will be described in detail by showing examples.

A film composed of NiFeNb with a thickness of 100 nm as a soft magnetic under layer 102 was formed by sputtering on a substrate 101 of glass with a thickness of 0.635 mm, and a film composed of MgO with a thickness of 3 nm as a non-magnetic seed layer 104 was formed on the under layer by sputtering. A film composed of an FePt alloy with a thickness of 10 nm was then formed on the non-magnetic seed layer 104 as a magnetic recording layer 105 by sputtering. A C film with a thickness of 5 nm as a protection layer 106 was then formed by sputtering, thereby a magnetic recording medium was obtained. For the purpose of obtaining a magnetization curve, a reference sample without a soft magnetic under layer was also prepared in order to prevent any influence from magnetization of the soft magnetic under layer.

The obtained magnetic recording medium was then subjected to a heat treatment under a vacuum atmosphere of 5×10⁻⁷ Torr at 600° C. for 3,600 seconds to achieve ordering of the magnetic recording layer of the medium.

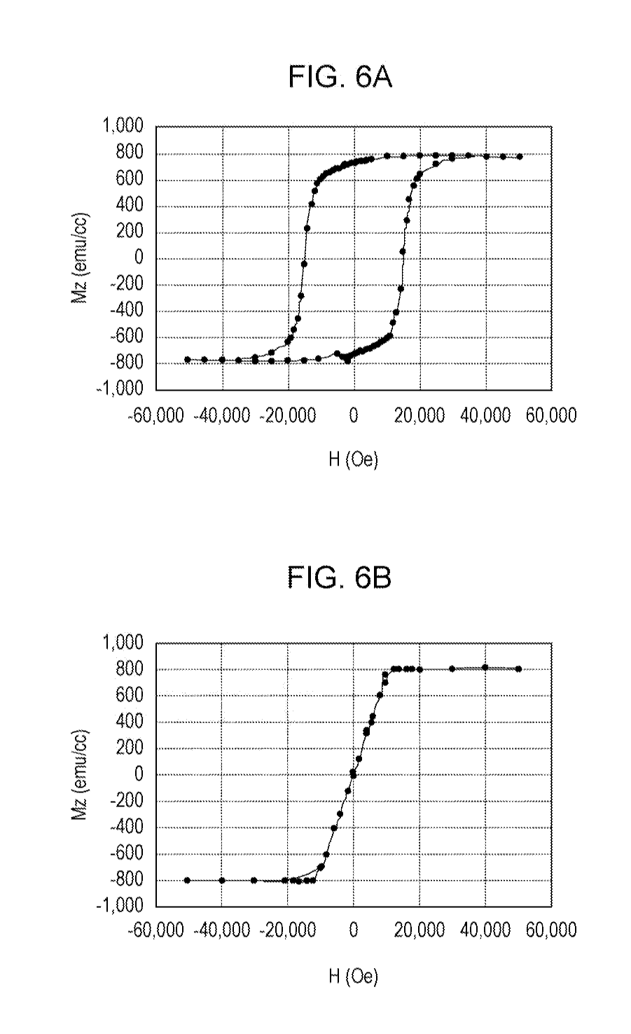

FIGS. 6A and 6B illustrate magnetization curves of an L10 ordered alloy for which ion irradiation was measured using a SQUID magnetometer. B ions of 1 at % were applied to an FePt ordered alloy with a thickness of 10 nm at an accelerating voltage of 3 keV to achieve a change in the magnetization curve by ion irradiation. FIG. 6A shows a magnetization curve before on irradiation and FIG. 6B shows a magnetization curve after ion irradiation. These figures reveal that the magnetic coercive force Hc was nearly zero, however, there was little change in the saturation magnetization Ms when the B ions were applied. This means that ion irradiation causes interdiffusion of Fe and Pt atoms, and an ordered alloy having a high-anisotropic L10 structure is transformed into a disordered alloy having an isotropic A1 structure, thereby the saturation magnetization remains no change and only the magnetic anisotropy is markedly decreased.

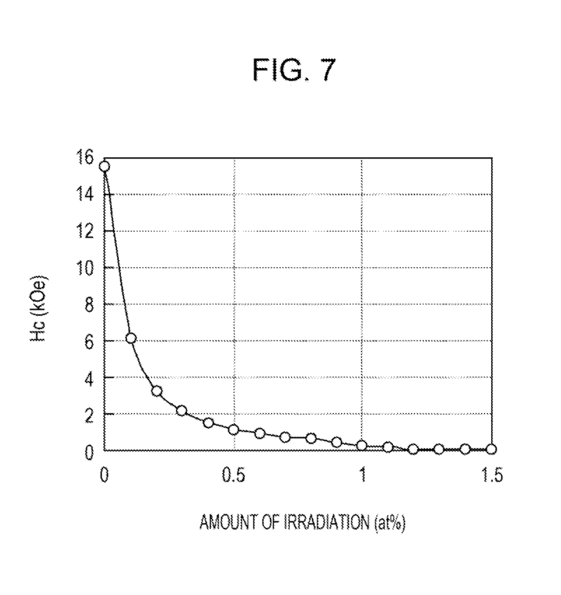

FIG. 7 illustrates the relationship between the amount of B ion irradiation and the magnetic coercive force of an ordered alloy. The change in the magnetic coercive force with the amount of ion irradiation was measured using a SQUID magnetometer. When B ions were applied at an accelerating voltage of 3 keV, the magnetic coercive force was decreased from about 16 kOe before irradiation to about 6 kOe at 0.1 at % irradiation, to about 1 kOe at 0.5 at % irradiation, and to nearly zero at 1 at % irradiation or higher. With respect to N, Ar, Cr, Nb, and Ga as well as B, the optimized accelerating voltage was obtained with the same Monte Carlo simulation and a similar evaluation was obtained, thereby it was confirmed that an equivalent change in magnetic coercive force is obtained.

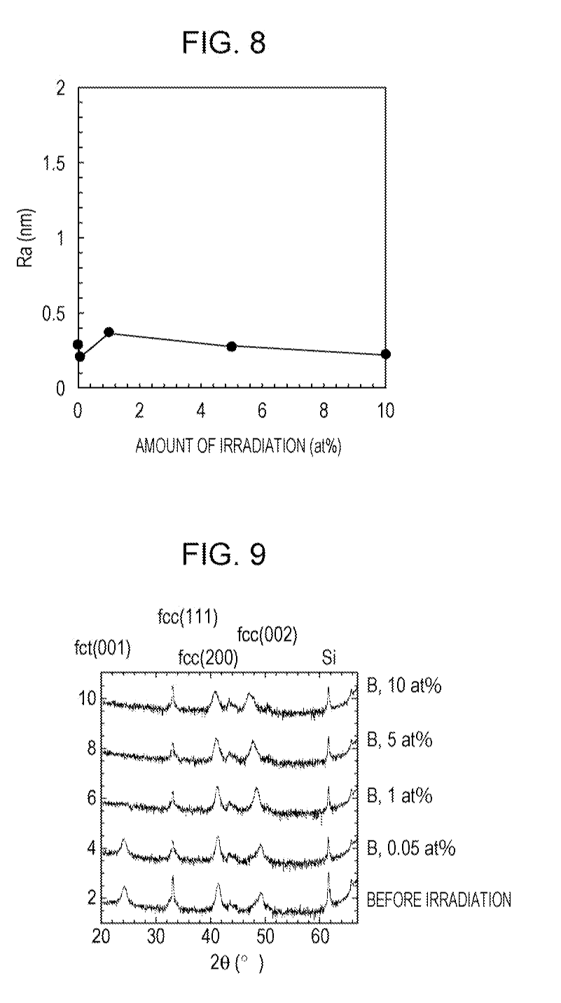

FIG. 8 illustrates the relationship of between the amount of B ions and the roughness of the medium surface. The variation in surface roughness at an amount of ion irradiation varying from 1 to 10 at % was measured. This reveals that there was little change in surface roughness depending on the amount of ion irradiation and there was little difference in surface roughness between no irradiation and 10 at % irradiation.

FIG. 9 shows the change in the crystalline structure of an L10 FePt ordered alloy subjected to ion irradiation measured by an X-ray diffraction method. The peak of a superlattice at Fct (001) corresponds to an ordered alloy phase, and it is revealed that the peak. completely disappeared with a B ion irradiation of 1 at % or higher and the crystalline structure transforms from fct or a tetragonal system to fcc or a cubic crystal system. Since other peaks of the basic lattice did not disappear even with 10 at % ion irradiation, it is considered that ion irradiation does not cause an alloy to become amorphous and magnetic anisotropy is markedly lowered upon transformation to an isotropic A1 structure.

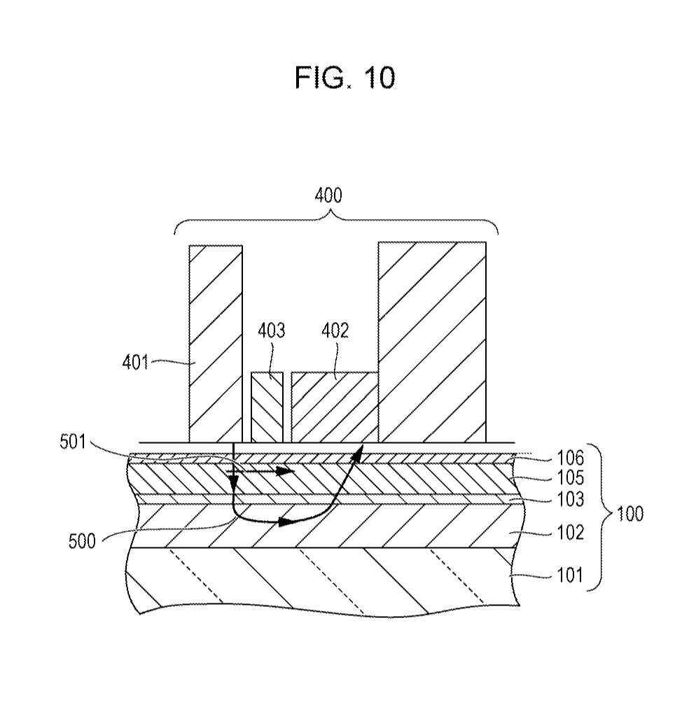

FIG. 10 is a sectional view illustrating the mechanism of a microwave-assisted magnetic recording method. A magnetic recording medium 100 has the soft magnetic under layer 102, the non-magnetic seed layer 104, the magnetic recording layer 105, and the protection layer 106 all of which are stacked on the substrate 101. Since the magnetic recording layer 105 has a perpendicular magnetic anisotropy, magnetization data is upwardly or downwardly recorded in the magnetic recording layer 105.

A magnetic head is placed on the magnetic recording medium 100. This magnetic head includes a recording head 400 and a reproduction head not shown in the drawing.

The recording head 400 is formed from a main magnetic pole 401 and a trailing shield 402 which is a return magnetic pole, a microwave magnetic generation element 403 is provided between the main magnetic pole 401 and the trailing shield 402.

A microwave magnetic field is generated around the Microwave magnetic field generating element 403 by applying a microwave excitation electric current to the microwave magnetic field generating element 403. Since the microwave magnetic generation element is close to the magnetic disk medium, a microwave magnetic field 501 is applied in a substantially horizontal direction in the medium. The magnetic coercive force of the magnetic recording layer 105 can be efficiently reduced by overlapping the microwave magnetic field 501 with the perpendicular recording magnetic field 500 applied from the main magnetic pole 401 of the recording head element 400 to the magnetic recording layer and, as a result, the necessary perpendicular writing magnetic field can be decreased.

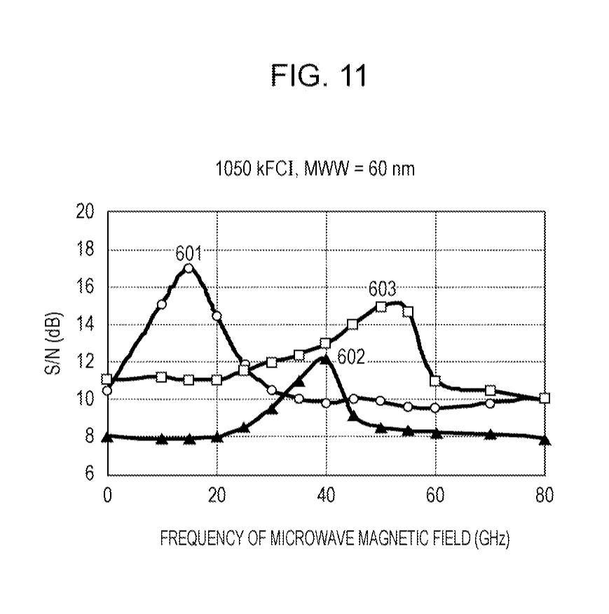

FIG. 11 illustrates a result of an LLG simulation of recording and reproducing characters when a microwave magnetic field was applied to some recording media including embodiments of the present invention. Conditions of the simulation include a line recording density of 1,050 kFCI, a width of recording track of 60 nm, a microwave magnetic field of 1,000 Oe for a linearly polarized wave, and a maximum head magnetic field of 11 kOe.

A curve 601 illustrates a medium model when an ordered alloy having an anisotropic magnetic field Hk of 40 kOe, a saturation magnetization MS of 800 emu/cc and a thickness t of 12 nm was transformed into an A1 disordered alloy having an anisotropic magnetic field of 0 Oe and a saturation magnetization Ms of 800 emu/cc by applying ions onto the surface of the ordered alloy up to a depth of nm. A curve 602 illustrates a medium model when a low anisotropic magnetic: film composed of a CoCrPt alloy having an anisotropic: magnetic field Hk of 40 kOe, a saturation magnetization MS of 500 emu/cc and a thickness t of 6 nm was stacked on an ordered alloy having an anisotropic magnetic field Hk of 40 kOe, a saturation magnetization Ms of 800 emu/cc and a thickness t of 6 nm. A curve 603 illustrates a model of a single-layered medium having an anisotropic magnetic field Hk of 20 kOe, a saturation magnetization Ms of 800 emu/cc and a thickness t of 6 nm.

As for the single-layered medium having a Hk of 20 kOe as represented by the curve 603, a maximum S/N of about 4 dB was obtained as an improved result by application of a microwave magnetic field, however, the frequency of a microwave magnetic field for obtaining an improved effect is as high as 40 to 55 GHz, and this is practically a problem. A laminate of an FePt alloy having an Hk of 40 kOe and a CoCrPt alloy having an Hk of 2 kOe as represented by the curve 602 produces a maximum S/N of about 4 dB as an improved result, however, the frequency of a microwave magnetic field for obtaining an improved effect is 30 to 45 GHz, and this is practically a problem. In addition, a head magnetic strength of 11 kOe is insufficient for recording and the absolute S/N is low. An FePt ordered alloy in which the anisotropic magnetic field Hk of the surface layer has been decreased from 40 kOe to zero as represented by the curve 601 produces an S/N of about 7 dB as an improved result at a practical microwave magnetic frequency of not more than 20 GHz, and therefore it is confirmed that this medium is suitable for a microwave-assisted mode.

Some preferred embodiments of the present invention are described in detail above, it should be understood that some modifications and alterations are possible without departing from the spirit or the scope of the invention claimed in the attached claims.

What is claimed is:

1. A magnetic recording medium having at least a soft magnetic under layer, a non-magnetic seed layer, a magnetic recording layer, and a protection layer on a substrate wherein the magnetic recording layer has a granular structure formed of ferromagnetic crystalline particles and a non-magnetic intergranular layer, the ferromagnetic crystalline particles are composed of an ordered alloy having an L10 crystalline structure at the side close to the substrate and a disordered alloy having an Al crystalline. structure at the side close to the surface in the direction of thickness of the magnetic recording layer.

2. The magnetic recording medium according to claim 1 wherein the ferromagnetic crystalline particles are composed of at least one element of Fe and Co and at least one element of Pt and Pd as a main component.

3. The magnetic recording medium according to claim 2 wherein the magnetic: recording layer has at least one element selected from B, N, Ar, Cr, Nb, and Ga, and the concentration of the element is higher at the side close the surface and lower at the side close to the substrate.

4. The magnetic recording medium according to claim 1, wherein the magnetic recording layer is separated by at least one non-magnetic layer.

5. A method for manufacturing the magnetic recording medium which includes forming a disordered alloy having an A1 crystalline structure by ion irradiation.

6. The method for manufacturing the magnetic recording medium according to claim 5 wherein the ions applied by the ion irradiation are of at least one element selected from B, N, Ar, Cr, Nb, and Ga.

7. A magnetic recording or reproducing apparatus into which the magnetic recording medium of claim 1 is incorporated.

8. The magnetic recording or reproducing apparatus according to claim 7 wherein a signal is recorded in the recording medium by imposing a microwave magnetic field generated from a microwave magnetic field generating element on a signal recording magnetic field generated from a recording head.
